(19) United States
(12) Patent Application Publication
(10) Pub. No.: US 2013/0316599 A1
(43) Pub. Date: Nov. 28, 2013

(54) CONNECTOR FOR TERMINATING TO A TERMINAL POST

(71) Applicants: Jose Roberto GOLDSCHMIDT, Campinas (BR); Fabio Fortunato CHRISTIANO, Itapira-SP (BR)

(72) Inventors: Jose Roberto GOLDSCHMIDT, Campinas (BR); Fabio Fortunato CHRISTIANO, Itapira-SP (BR)

(73) Assignee: TYCO ELECTRONICS BRASIL LTDS, Sao Paulo (BR)

(21) Appl. No.: 13/480,552

(22) Filed: May 25, 2012

(51) Int. Cl. H01R 4/44

(52) U.S. Cl. 439/782

(57) ABSTRACT

A connector for terminating to a terminal post. The connector has a connector body and a lever. The connector body has clamping arms, with the clamping arms having outwardly directed cam surfaces. The lever is connected to the connector body for pivotal movement thereabout between an unclamped position and a clamped position. The lever has activation members with inwardly directed cam surfaces. The rotation of the lever from the unclamped position to the clamped position causes the inwardly directed cam surface to progressively engage the outwardly directed cam surfaces, causing the clamping arms to be moved toward each other thereby clamping the connector to the terminal post without the need for tools.

### FIELD OF THE INVENTION

The present invention is directed generally to a connector for terminating to a terminal post, such as a battery terminal More particularly, the present invention relates to a connector that can be quickly released by hand without requiring any tools.

### BACKGROUND OF THE INVENTION

Batteries are used as a mobile source of power for a wide variety of devices and equipment. Batteries are also used in many vehicles and other types of equipment to ignite a combustion engine. For those devices in which a battery is used, the terminals of the battery are electrically connected to the electrical system in that device equipment or vehicle. Thus, battery terminal connectors are required for connecting the battery to an electrical system in, for example, an automobile, water craft, recreational vehicle, tractor, truck, lawn mower, etc.

Periodically, it is necessary for a battery to be replaced. This may occur because the battery looses the capacity to function properly by being depleted of its charge. In some cases, such as in an automobile, the battery is normally recharged during operation of the device that battery serves. However, even where the battery is rechargeable, it will eventually, through wear and tear, become unable to accept and maintain a charge and will have to be replaced. Additionally, when work is being done on or near the electrical system of, for example, a vehicle, it may be a wise precaution to disconnect the battery from the electrical system to prevent the possibility of being shocked or having an electrical surge damage tools or the equipment being serviced.

Battery cables are typically attached to the terminal post of a battery using a clamp type battery connector. These connectors include a barrel portion for accommodating a stripped end of the battery cable and a clamping portion which is positioned about the upstanding terminal post. The clamping portion may be tightened around the terminal post to provide secure connection thereto. The clamping portion of most battery connectors includes a pair of arms defining a circular portion therebetween which may be positioned around the battery terminal post. The ends of the arms may be brought together with a fastening device such as a nut and bolt to tightly secure the arms about the battery post. As an example, a nut at one end of the bolt can be tightened in order for the clamp to be tightened and grip a battery terminal, which frequently requires the use of at least one, maybe two, wrenches or similar tools such as pliers. Similarly, the action of releasing the nut from the bolt, and thus releasing the clamp from the battery terminal, which also frequently requires the use of at least one, maybe two, wrenches or similar tools such as pliers.

This is often inconvenient and time consuming for a number of reasons. As an example, there may not be any of the desired tools readily at hand when it is desired to release a battery terminal connector. Additionally, the battery terminal and connector clamp may be corroded making it difficult to grip the bolt or nut and release the clamp. The nut on the bolt may be stripped and difficult to loosen. Or, the mere location of the battery may obstruct the use of wrenches or other tools to loosen the connector clamp.

The art has also seen a number of quick connection clamp type cable connectors where clamping is facilitated by an actuator attached to the clamp. This type of quick connection clamp enables the user to connect the cable to the battery terminal post without need of operating a fastener such as a nut and bolt. Many of these quick connect battery connectors employ a lever arm which is attractable to bring two halves of a clamp connector together about the upstanding battery post, such as shown in U.S. Pat. No. 6,773,310. However, the mere location of the battery may obstruct or limit the types of actuated connectors, as space may restrict the motion or the ability to access the levers. In addition, the configuration of the quick connect clamps of the prior art causes the connectors to be placed in electrical connection with the posts through a relatively harsh snapping engagement, which can cause damage to the connector, terminal posts and/or the operator.

It is, therefore, desirable to provide a clamp type cable connector for attachment to a battery terminal post which overcomes the disadvantages described, including providing an actuation mechanism which can be easily accessed and which clamps the connector to the terminal post using a controlled, progressive, easily repeatable force.

### SUMMARY OF THE INVENTION

An exemplary embodiment is directed to a connector for terminating to a terminal post. The connector has a connector body and a lever. The connector body has clamping arms, with the clamping arms having outwardly directed cam surfaces. The lever is connected to the connector body for pivotal movement thereabout between an unclamped position and a clamped position. The lever has activation members with inwardly directed cam surfaces. The rotation of the lever from the unclamped position to the clamped position causes the inwardly directed cam surface to progressively engage the outwardly directed cam surfaces, causing the clamping arms to be moved toward each other thereby clamping the connector to the terminal post.

An exemplary embodiment is directed to a connector for terminating to a terminal post. The connector has a connector body and a lever. The connector body has clamping arms, with the clamping arms having cam surfaces. The lever is connected to the connector body for pivotal movement thereabout between an unclamped position and a clamped position. The lever has cam surfaces and a terminal post receiving opening. A mounting device is provided to hold the lever in pivotal relationship to the clamping arms. The rotation of the lever from the unclamped position to the clamped position causes the cam surface of the lever to engage the cam surfaces of the clamping arms, causing the clamping arms to be moved toward each other thereby clamping the connector to the terminal post. The rotation of the lever from the unclamped position to the clamped position also causes the terminal post receiving opening of the lever to be moved over the terminal post.

An exemplary embodiment is directed to a connector for terminating to a terminal post. The connector has a connector body and a lever. The connector body has clamping arms, with the clamping arms having outwardly directed inclined cam surfaces. The lever is connected to the connector body for pivotal movement thereabout between an unclamped position and a clamped position. The lever has activation members with inwardly directed inclined cam surfaces. The rotation of the lever from the unclamped position to the clamped position causes the inwardly directed inclined cam surface to progressively engage the outwardly directed inclined cam surfaces, causing the clamping arms to be moved toward each other thereby clamping the connector to the terminal post.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an exemplary embodiment of a connector of the present invention positioned proximate to a post of the battery in the unclamped condition.

FIG. 2 is a perspective view of the connector of FIG. 1 electrically connected to the post of the battery in the clamped condition.

FIG. 3 is perspective view of the exemplary connector with a lever of the connector removed from a body of the connector to better show the engagement portions positioned on both the lever and the body.

FIG. 4 is a cross-sectional view of the connector with the lever in the unclamped position.

FIG. 5 is a cross-sectional view of the connector with the lever positioned between the unclamped position and clamped position.

FIG. 6 is a cross-sectional view of the connector with the lever in the clamped position.

### DETAILED DESCRIPTION OF THE INVENTION

The present invention provides for a tool-less battery terminal connector for quickly connecting and disconnecting to a terminal post, such as a battery terminal post.

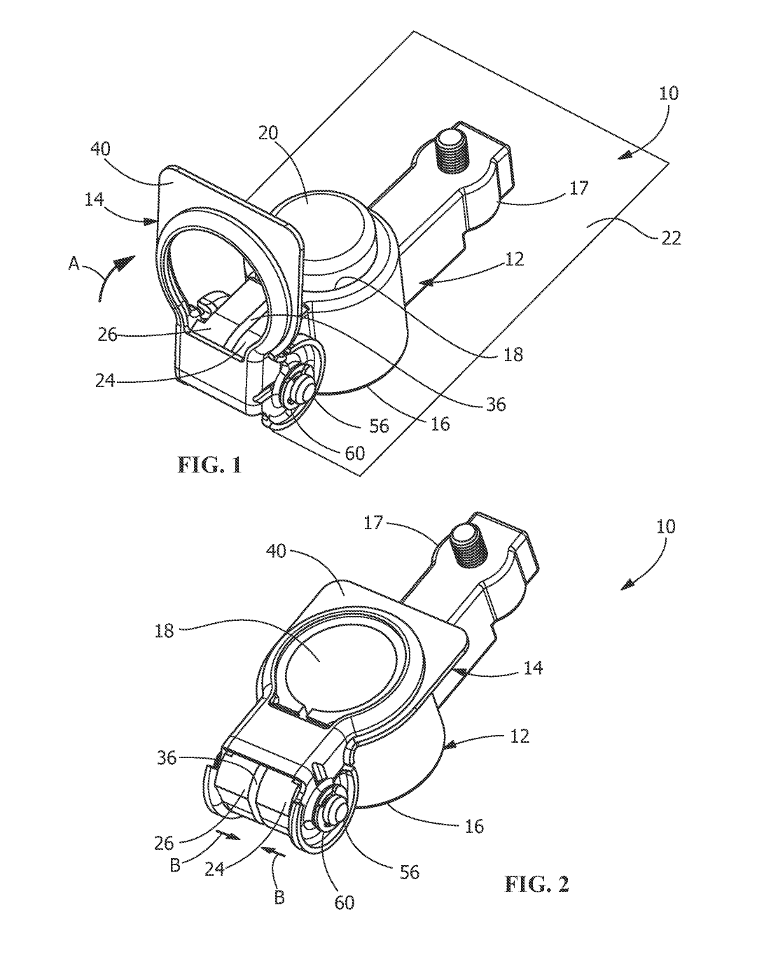

Referring to FIGS. 1 and 2, an exemplary embodiment of a battery terminal connector 10 of the present invention is shown. The connector 10 includes a connector body 12 and a lever 14 which is connected to body 12 for pivotal movement thereabout. The connector body 12 includes a clamping end 16 and an opposed termination end 17 extending therefrom.

The clamping end 16 includes an aperture 18 extending therethrough which is designed for accommodation over an upstanding terminal post 20 of a battery 22. The aperture 18 forms nearly a full circle to encompass the post 20. The clamping end 16 further includes a pair of spaced apart outwardly extending movable clamping arms 24, 26 which provide for clamping engagement about the post 20.

The clamping arms 24, 26 are separated by a slot 36 which extends to the aperture 18. The width of the slot 36 may vary depending upon whether the connector 10 is in a clamped (closed) or an unclamped (open) position, as will be more fully described.

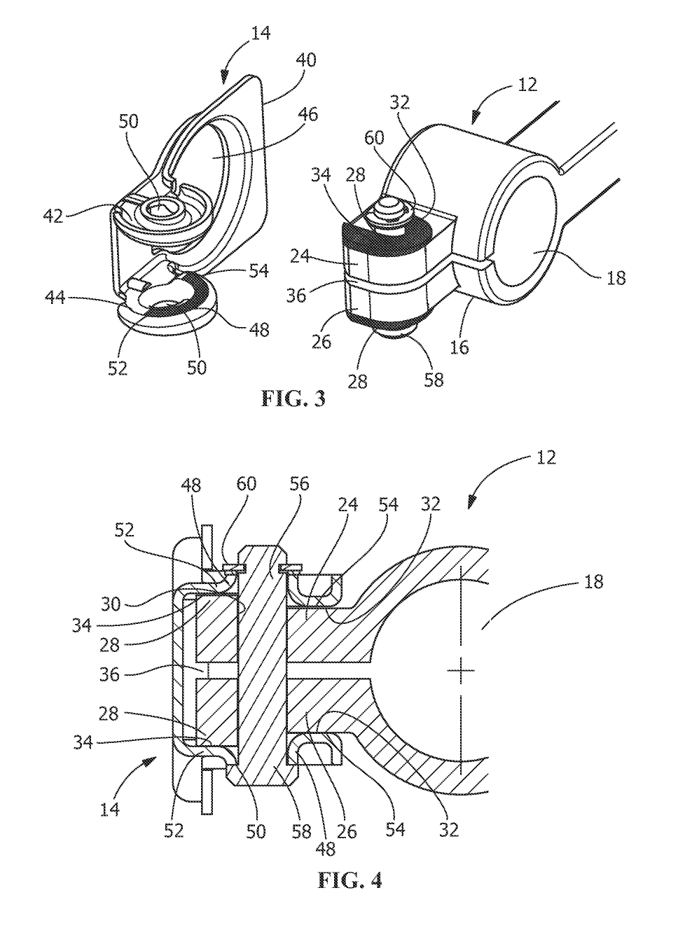

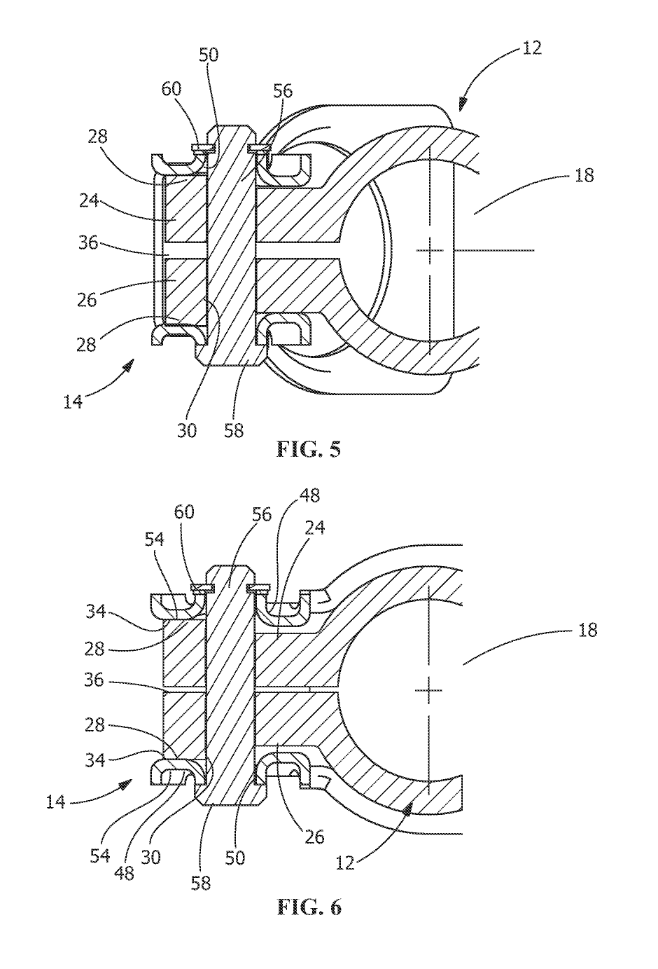

As best shown in FIG. 3, the clamping arms 24, 26 are generally rectangular with a curved outer end. A mounting opening 30 (as best shown in FIG. 5) extends through the clamping arms 24, 26 adjacent the curved outer end. The clamping arms 24, 26 have an inner surface adjacent the slot 36 and an outer surface opposite the inner surface. At the curved outer end, the outer surface comprises outwardly directed inclined tapering ramps or cam surfaces 28 which extend circumferentially about portions of openings 30. Each cam surface 28 has a thin end 32 and a thick end 34. The thickness of the cam surface gradually increases from the thin end 32 to the thick end 34.

The termination end 17 of body 12 allows accommodation of the stripped end of an electrical cable, such as a battery cable (not shown). The barrel of the termination end 17 may be attached to the cable in conventional fashion. Alternatively, other configurations of the termination end 17 and other methods of termination may be used without departing from the scope of the invention.

As best shown in FIG. 3, the lever 14 is a generally L-shaped member having an operator engagement portion 40 extending along a first leg and a pair of spaced apart activation members 42, 44 extending along a second leg. The engagement portion 40 comprises a generally rectangular plate with a free end and an attached end and having an opening 46 approximate the center of the plate. The activation members 42, 44 extend from sides of the engagement portion 40 at the attached end and are essentially perpendicular thereto. The opening 46 is dimensioned to provide clearance for and extend around the post 20 (FIG. 1) of the battery 22 when the lever 14 is in the clamped position. In the exemplary embodiment, the activation members 42, 44 comprise a generally circular shape having a generally U-shaped cross section with a mounting opening 50 extending through approximate the center, an inner surface, and an outer surface.

The inner surfaces of the activation members 42, 44 have inwardly directed tapering ramps, inclined or cam surfaces 48 which extend circumferentially about portions of openings 50. Each cam surface 48 has a thin end 52 and a thick end 54. The thickness of the cam surface gradually increases from the thin end 52 to the thick end 54.

As shown in FIG. 3, when assembled, the inner surfaces of the activation members 42, 22 of the lever 14 are placed adjacent the outer surface of the clamping arms 24, 26 of the housing 12. As further described below, when the lever is activated to move from the open position to the closed position, the cam surface 48 moves along the cam surface 28. In the exemplary embodiment, both surfaces are inclined providing cam action however it should be understood that in alternative embodiments one or the other surface may not be inclined.

Referring again to FIGS. 1 and 2, a mounting device, which in the exemplary embodiment shown is a pivot pin 56 is provided to hold the lever 14 in pivotable relationship to the clamping arms 24, 26. The pivot pin 56 is provided and extends through the openings 30 (FIG. 4) of the clamping arms 24, 26 and the openings 50 (FIG. 3) of the activation members 42, 44. The pivot pin 56 is seated in the openings 30, 50 to allow for rotational movement of the lever 14 with respect to the body 12. The pin 56 has an enlarged head 58 (FIG. 3) which is dimensioned to have a circumference larger than the circumference of openings 50. A lock washer 60 or the like is provided proximate the end of the pivot pin 56 opposite the head 58. The head 58 and the lock washer 60 cooperate to maintain the pivot pin 56 in position relative to the lever 14 and the body 12. The combination of the head 58 and lock washer 60 also prevents the inadvertent removal of the lever 14 from the body 12. Alternate embodiments may be suitable to maintain the pin 56 relative to the lever 14 such as a cotter pin or the like.

As the connector 10 of the present invention is designed to terminate an electrical cable, such as a battery cable, to the terminal post 20 of the battery 22, the body 12 of the connector 10 is typically formed of an electrically conductive metal, such as copper, aluminum or steel to provide conductivity. The body 12 may be cast, forged, stamped or otherwise formed using other know methods. The lever 14 may be stamped and formed from different materials, including, but not limited to, non-conductive materials.

Referring to FIGS. 1 and 4, the assembled connector 10 of the present invention is shown inserted onto the post 20 of the battery 22, with the lever 14 in an unclamped position. In this position, the activation members 42, 44 of the lever 14 are positioned proximate the clamping arms 24, 26 of the body 12 and are maintained in position by the pivot pin 56. As best shown in FIG. 4, the thin ends 52 of the cam surfaces 48 of the activation members 42, 44 are positioned proximate the thick ends 34 of the cam surfaces 28 of the clamping arms 24, 26. In this position, the thick ends 54 of the cam surfaces 48 of the activation members 42, 44 are positioned proximate the thin ends 32 of the cam surfaces 28 of the clamping arms 24, 26. In this position, the activation members 42, 44 of the lever 14 are positioned proximate the clamping arms 24, 26 of the body 12 and do not exert a force thereon. The clamping arms 24, 26 of the body 12 are therefore unstressed and the slot 36 and aperture 18 are in their open position. This allows the connector 10 to be assembled to and removed from the upstanding post 20 of battery 22.

Referring to FIGS. 2 and 6, the assembled connector 10 of the present invention is shown in the closed position. In the closed position the connector 10 is inserted onto and provided in electrical engagement with the post 20 (FIG. 1) of the battery 22 (FIG. 1), with the lever 14 is shown in a clamped position. In this position, the activation members 42, 44 of the lever 14 are positioned proximate the clamping arms 24, 26 of the body 12 and are maintained in position by the pivot pin 56. As best shown in FIG. 6, the thick ends 54 of the cam surfaces 48 of the activation members 42, 44 (FIG. 3) are positioned proximate to and in engagement with the thick ends 34 of the cam surfaces 28 of the clamping arms 24, 26. In this position, the activation members 42, 44 of the lever 14 are positioned proximate to and in engagement with the clamping arms 24, 26 of the body 12 and exert a force thereon. As the activation members 42, 44 are prevented from moving away from the clamping arms 24, 26 because of the rigidity of the activation members 42, 44, the forces exerted by the movement of the activation members 42, 44 are directed inward, causing the clamping arms 24, 26 to be moved toward each other. In addition, the positioning of the head 58 and lock washer 60 prevents the outward movement of the activation members 42, 44, thereby insuring the forces are directed inward. The clamping arms 24, 26 of the body 12 are therefore moved to a stressed position, causing the slot 36 and aperture 18 to contract or become smaller, thereby moving the slot 36 and the aperture 18 to a clamped position. This allows the connector 10 to be secured to the upstanding post 20 (FIG. 1) of battery 22, thereby providing a secure electrical connection therebetween. In this position, the engagement portion 40 of the lever 14 is positioned proximate the body 12, with the plane of the lever 14 being essentially parallel to the plane of a top surface of the body 12. In addition, the opening 46 extends around the post 20 of the battery 22.

As will be described in further detail hereinbelow, the engagement between inwardly directed cam surfaces 48 of activation members 42, 44 with the outwardly directed cam surfaces 28 of clamping arms 24, 26 provides for the deformable inward movement of clamping arms 24, 26 to clamp body 12 about post 20 upon rotation of lever 14 to a closed position.

Referring now to FIGS. 4 through 6, the lever 14 is shown moving from the open or unclamped position to the closed or clamped position in which the connector body 12 is clamped to the terminal post 20 of battery 22. As the lever 14 is rotated in the direction of arrow A (FIG. 1) so that the engagement portion 40 moves from the open position shown in FIG. 1 to the closed position shown in FIG. 2, the cam surfaces 48 of the activation members 42, 44 engage the cam surfaces 28 of the clamping arms 24, 26, as best shown in FIG. 5. This causes the deformable clamping arms 24, 26 to be moved inwardly as shown by the arrows B in FIG. 2 to clamp the connector body 12 about terminal post 20. As the cam surface 28, 48 are tapered or inclined, the force needed to move the lever 14 between the unclamped position and the clamped position is gradually built up or lessened, allowing for the lever to be moved in an easy, controlled manner without the use of tools.

The progressive engagement of the cam surfaces 48 and 28, represented by FIGS. 4 through 6, creates a gradient force which causes the clamping arms 24, 26 to provide secure clamping engagement about the post 20. The use of the cam surfaces 28 and 48 also creates a controlled, specific and repeatable force which causes a specific movement or deformation of the clamping arms 24, 26 and the aperture 18, which in turn provides a controlled, specific and repeatable electrical connection between the connector 10 and the terminal post 20.

A locking device may be provided for maintaining the lever 14 in the clamped position, thereby preventing inadvertent movement of the lever 14 and unclamping of the connector due to forces such as vibratory forces or other inadvertent contact during use.

While the exemplary embodiment shown has tapered or inclined surface of all cam surfaces 28, 48, other embodiments are possible without departing from the scope of the invention. In one exemplary alternate embodiment, cam surfaces 28 may be inclined while cam surfaces 48 may be a raised projection or flat surface. In this embodiment, the pivoting of the lever 14 causes the cam surfaces 48 to move relative to the cam surfaces 28, causing the thick ends 34 of cam surfaces 28 to engage the cam surfaces 48 resulting in the same movement of the clamping arms 24, 26 as previously described. In a second exemplary alternate embodiment, cam surfaces 48 may be inclined while cam surfaces 28 may be a raised projection or flat surface. In this second exemplary alternate embodiment, the pivoting of the lever 14 causes the cam surfaces 48 to move relative to the cam surfaces 28, causing the thick ends 54 of cam surfaces 48 to engage the cam surfaces 28 resulting in the same movement of the clamping arms 24, 26 as previously described.

The present invention thus allows for the clamping and unclamping of the connector to the terminal post without need for separate fastening members to hold the connector body onto the terminal post.

As the connector of the present invention is designed to preferably terminate a battery cable to a terminal post of a battery, two connectors are commonly employed with a single battery. Often, the positive terminal has a different diameter from the negative battery terminal. It is contemplated that two different size connectors may be manufactured. One would be for the positive terminal which has a first size and the other would be for the negative terminal which has a second size different from the first size. In these instances, the connector of the present invention may also be color coded to indicate which size and which terminal is to be used with each connector.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

1. A connector for terminating to a terminal post, the connector comprising;
a connector body having clamping arms;
a lever connected to the connector body for pivotal movement thereabout between an unclamped position and a clamped position, the lever having activation members;
the clamping arms having outwardly directed cam surfaces;
the activation members having inwardly directed cam surfaces;
wherein the rotation of the lever from the unclamped position to the clamped position causes the cam surfaces of the activation members to progressively engage the cam surfaces of the clamping arms, causing the clamping arms to be moved toward each other thereby clamping the connector to the terminal post.

2. The connector as recited in claim 1, wherein the cam surfaces of the clamping arms are inclined.

3. The connector as recited in claim 1, wherein the cam surfaces of the activation members are inclined.

4. The connector as recited in claim 1, wherein the cam surfaces of the clamping arms are inclined and the cam surfaces of the activation members are inclined.

5. The connector as recited in claim 1, wherein the connector body has an aperture which extends therethrough for accommodation over the terminal post.

6. The connector as recited in claim 2, wherein the cam surfaces of the clamping arms extend circumferentially about portions of openings which extend through the clamping arms.

7. The connector as recited in claim 2, wherein the cam surfaces of the clamping arms have thin ends and thick ends, with the thickness of the outwardly directed cam surfaces increasing from the thin ends to the thick ends.

8. The connector as recited in claim 1, wherein the activation members are spaced apart and extend from an engagement portion of the lever, the engagement portion has an opening which is spaced from the activation members, the opening dimensioned to provide clearance for and extend around the terminal post.

9. The connector as recited in claim 3, wherein the cam surfaces of the activation members extend circumferentially about portions of openings which extend through the activation members of the lever.

10. The connector as recited in claim 3, wherein the cam surfaces of the activation members have thin ends and thick ends, with the thickness of the inwardly directed inclined cam surfaces increasing from the thin ends to the thick ends.

11. The connector as recited in claim 1, wherein a mounting device is provided to hold the lever in pivotable relationship to the clamping arms.

12. A connector for terminating to a terminal post, the connector comprising;
a connector body having clamping arms;
a lever connected to the connector body for pivotal movement thereabout between an unclamped position and a clamped position;
the clamping arms having cam surfaces;
the lever having cam surfaces and a terminal post receiving opening;
a mounting device provided to hold the lever in pivotal relationship to the clamping arms;
wherein the rotation of the lever from the unclamped position to the clamped position causes the cam surfaces of the lever to engage the cam surfaces of the clamping arms, causing the clamping arms to be moved toward each other thereby clamping the connector to the terminal post;
wherein the rotation of the lever from the unclamped position to the clamped position causes the terminal post receiving opening of the lever to be moved over the terminal post.

13. The connector as recited in claim 12, wherein the cam surfaces of the lever are inwardly directed inclined cam surfaces having thin ends and thick ends, with the thickness of the inwardly directed inclined cam surfaces increasing from the thin ends to the thick ends, the inwardly directed inclined cam surfaces extend circumferentially about portions of mounting openings which extend through the lever.

14. The connector as recited in claim 12, wherein the cam surfaces of the clamping arms are outwardly directed inclined cam surfaces which extend circumferentially about portions of openings which extend through the clamping arms, the outwardly directed cam surfaces have thin ends and thick ends, with the thickness of the outwardly directed inclined cam surfaces increasing from the thin ends to the thick ends.

15. The connector as recited in claim 13, wherein the lever has activation members which extend from an engagement portion of the lever, the activation members have the inwardly directed inclined cam surfaces provided thereon, the engagement portion has an terminal post receiving opening which is spaced from the activation members, the terminal post receiving opening dimensioned to provide clearance for and extend around the terminal post when the lever is in the clamped position.

16. A connector for terminating to a terminal post, the connector comprising;
a connector body having clamping arms;
a lever connected to the connector body for pivotal movement thereabout between an unclamped position and a clamped position, the lever having activation members;
the clamping arms having outwardly directed inclined cam surfaces;
the lever having inwardly directed inclined cam surfaces;
wherein the rotation of the lever from the unclamped position to the clamped position causes the inwardly directed inclined cam surface to progressively engage the outwardly directed inclined cam surfaces, causing the clamping arms to be moved toward each other thereby clamping the connector to the terminal post.

17. The connector as recited in claim 16, wherein the connector body has an aperture which extends therethrough for accommodation over the terminal post of a battery.

18. The connector as recited in claim 16, wherein the lever has a pair of spaced apart activation members which extend from an engagement portion, the activation members have the inwardly directed inclined cam surfaces provided thereon, the engagement portion has an opening which is spaced from the activation members, the opening dimensioned to provide clearance for and extend around the terminal post when the lever is in the clamped position.

19. The connector as recited in claim 18, wherein a pivot pin extends through mounting openings of the clamping arms and mounting openings of the activation members, the pivot pin is seated in the mounting openings to allow for rotational movement of the lever with respect to the connector body.

20. The connector as recited in claim 19, wherein the pin has an enlarged head and a lock washer, the head is dimensioned to have a circumference larger than the circumference of mounting openings of the clamping arms, the lock washer is provided proximate the end of the pivot pin opposite the head, the head and the lock washer cooperate to maintain the pivot pin in position relative to the lever and the connector body.
